(19) United States
(12) Patent Application Publication
(10) Pub. No.: US 2006/0055655 A1
(43) Pub. Date: Mar. 16, 2006

(54) Driving unit and display apparatus having the same

(75) Inventors: Dong-Wan Choi, Seoul (KR); Dong-Hwan Kim, Suwon-si (KR); Byung-Chang Shim, Yongin-si (KR)

Correspondence Address: David W. Heid;MacPHERSON KWOK CHEN & HEID LLP, Suite 226, 1762 Technology Drive, San Jose, CA, 95110, US

(73) Assignee: SAMSUNG ELECTRONICS CO., LTD., Suwon-si (KR)

(21) Appl. No.: 11/225,294

(22) Filed: Sep. 13, 2005

(30) Foreign Application Priority Data
Sep. 15, 2004 (KR) 2004-73817

(51) Int. Cl. G09G 3/36

(52) U.S. Cl. 345/98

(57) ABSTRACT

In a driving unit and a display apparatus, a master driving chip includes a common voltage generator configured to receive power and generate a master common voltage and a slave common voltage and a first data driver configured to output a master image signal based on the master common voltage and a master data signal. A slave driving chip includes a second data driver configured to output a slave image signal based on the slave common voltage from the common voltage generator and a slave data signal. Accordingly, the malfunction of the driving unit and the display apparatus may be prevented.

### CROSS-REFERENCE TO RELATED APPLICATION

This application relies for priority upon Patent Application No. 2004-73817 filed in the Korean Intellectual Property Office, Republic of Korea, on Sep. 15, 2004, the entire content of which is hereby incorporated herein by reference.

### BACKGROUND OF THE INVENTION

1. Field of the Invention

The present invention relates to an improved driving unit and a display apparatus having the improved driving unit. More particularly, the present invention relates to an improved driving unit capable of preventing a malfunction thereof and a display apparatus having the improved driving unit.

2. Description of the Related Art

FIG. 1 is a plan view showing a conventional liquid crystal display apparatus. FIG. 2 shows input waveform diagrams of first and second data drivers shown in FIG. 1.

Referring now to FIG. 1, a conventional liquid crystal display apparatus 40 includes a liquid crystal display panel 10 displaying an image, a first data driving chip (or electronic circuit) 20 and a second data driving chip 30. The first and second data driving chips 20 and 30 apply an image signal to the liquid crystal display panel 10. The first data driving chip 20 has a first data driver 21 and a first common voltage generator 22 therein, and the second data driving chip 30 has a second data driver 31 and a second common voltage generator 32 therein.

The first data driver 21 receives a first common voltage Vcom1 from a first common voltage generator 22 and a first externally provided data signal DATA1. The first data driver 21 outputs an image signal generated by a voltage difference between the first common voltage Vcom1 and the first data signal DATA1. The second data driver 31 receives a second common voltage Vcom2 from a second common voltage generator 32 and a second externally provided data signal DATA2. The second data driver 31 outputs an image signal generated by a voltage difference between the second common voltage Vcom2 and the second data signal DATA2. The voltage difference indicates a high-and-low of the data signal with reference to the common voltage. In general, when the voltage difference between the common voltage and the data signal becomes larger, the liquid crystal display panel 10 displays a white gray-scale. On the contrary, when the voltage difference between the common voltage and the data signal becomes smaller, the liquid crystal display panel 10 displays a black gray-scale.

In reference to FIG. 2, the first and second common voltages Vcom1 and Vcom2 are obtained from one signal so that the first common voltage Vcom1 typically has a voltage level equal to the second common voltage Vcom2. In the above apparatus, each of the first and second common voltages Vcom1 and Vcom2 has a voltage level periodically inverted. However, one of the first and second common voltages Vcom1 and Vcom2 is inverted due to static electricity. When one of the first and second common voltages Vcom1 and Vcom2 is inverted, a malfunction of the liquid crystal display apparatus 40 can result where the gray scales of the left and right screens A₁ and A₂ of the liquid crystal display panel 10 are inverted.

More specifically, due to the presence of an electric field between the first common voltage Vcom1 and the first data signal DATA1 shown in FIG. 1, the white gray-scale is displayed on the left screen A₁ driven by the first data driving chip 20, while the black gray-scale is displayed on the right screen A₂ driven by the second data driving chip 30. As described above, the liquid crystal display apparatus 40, having at least two data driving chips, is malfunctioned due to a conversion of the gray-scales between the left screen A₁ and the right screen A₂.

### SUMMARY OF THE INVENTION

In accordance with one or more embodiments, the present invention provides an improved driving unit capable of preventing malfunctions and a display apparatus having the improved driving unit.

In one embodiment, a driving unit includes a master driving chip and a plurality of slave driving chips. The master driving chip has a common voltage generator and a first data driver. The common voltage generator receives power from an external source and generates both a master common voltage and a slave common voltage. The first data driver outputs a master image signal in response to, or based on, the master common voltage and an externally provided master data signal. Each of the slave driving chips has a second data driver that outputs a slave image signal in response to the slave common voltage from the common voltage generator and an externally provided slave data signal.

In another embodiment, a display apparatus includes a display panel, a gate driver, a master driving chip and a plurality of slave driving chips. The display panel displays an image in response to a master image signal, a slave image signal and a gate signal, while a gate driver outputs the gate signal. The master driving chip has a common voltage generator and a first data driver. The common voltage generator receives power from an external source and generates a master common voltage and a slave common voltage. The first data driver outputs a master image signal in response to the master common voltage and a master data signal that is externally provided. Each of the slave driving chips has a second data driver to output a slave image signal in response to the slave common voltage from the common voltage generator and a slave data signal that is externally provided.

As described above, the master common voltage and the slave common voltage are inverted simultaneously when the static electricity occurs, so that a malfunction of the display panel may be prevented due to the static electricity.

### BRIEF DESCRIPTION OF THE DRAWINGS

The above and other advantages of the present invention will become readily apparent by reference to the following detailed description when considered in conjunction with the accompanying drawings, wherein:

FIG. 1 is a plan view showing a conventional liquid crystal display apparatus;

FIG. 2 shows waveform diagrams of first and second data drivers shown in FIG. 1;

FIG. 3 is a block diagram showing a driving unit according to a first exemplary embodiment of the present invention;

FIG. 4 is a block diagram showing a common voltage generator shown in FIG. 3;

FIG. 5 shows waveform diagrams of exemplary signals applied to the first and second data drivers shown in FIG. 3;

FIG. 6 shows waveform diagrams of exemplary signals applied to the first and second data drivers shown in FIG. 3;

FIG. 7 is a block diagram showing rear sides of the master and slave driving chips shown in FIG. 3;

FIG. 8 is block diagram of a driving unit according to a second exemplary embodiment of the present invention;

FIG. 9 is a plan view showing a display apparatus according to a third exemplary embodiment of the present invention;

FIG. 10 is a plan view showing a display apparatus according to a fourth exemplary embodiment of the present invention; and

FIG. 11 is a plan view showing a display apparatus according to a fifth exemplary embodiment of the present invention.

### DESCRIPTION OF THE PREFERRED EMBODIMENTS

Hereinafter, the present invention will be explained in detail with reference to the accompanying drawings.

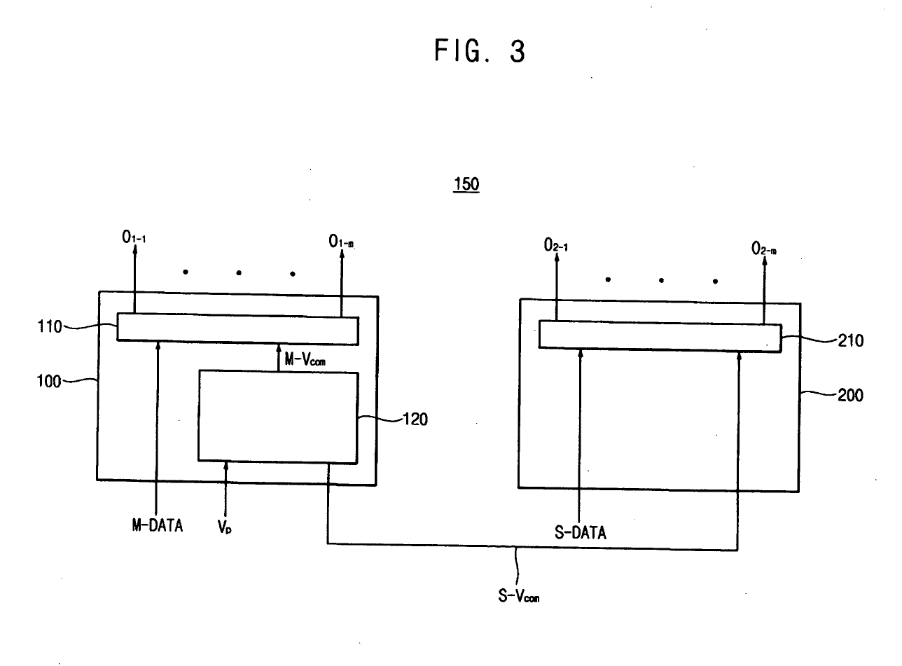

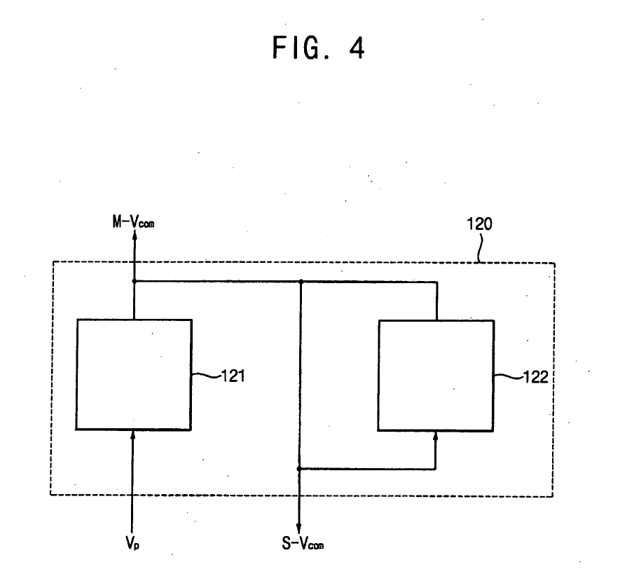

FIG. 3 is a block diagram showing a driving unit according to a first exemplary embodiment of the present invention, and FIG. 4 is a block diagram showing a common voltage generator 120 shown in FIG. 3.

Referring now to FIG. 3, a driving unit 150 according to a first exemplary embodiment of the present invention includes a master driving chip 100 and a slave driving chip 200. The master driving chip 100 has a first data driver 110 and a common voltage generator 120. The common voltage generator 120 converts an externally provided power voltage Vp to a master common voltage M-Vcom and a slave common voltage S-Vcom. The first data driver 110 outputs first to m-th master image signals 01-1 to 01-m in response to the master common voltage M-Vcom and a master data signal M-DATA. An electric field difference between the master common voltage M-Vcom and the master data signal M-DATA is outputted as the first to the m-th master image signals 01-1 to 01-m. In the first embodiment, “m” is a natural number not less than “2”. The slave driving chip 200 has a second data driver 210 receiving a slave data signal S-DATA and the slave common voltage S-Vcom from the master driving chip 100 and outputting first to m-th slave image signals 02-1 to 02-m. An electric field difference between the slave common voltage S-Vcom and the slave data signal S-DATA is outputted as the first to the m-th slave image signals 02-1 to 02-m.

As shown in FIG. 4, the common voltage generator 120 includes a converter 121 converting the externally provided power voltage to the master and slave common voltages M-Vcom and S-Vcom and an inverter 122 periodically inverting the master and slave common voltages M-Vcom and S-Vcom. Thus, the master and slave common voltages M-Vcom and S-Vcom from the converter 121 are fed back to the inverter 122 and periodically inverted by the inverter 122. In the present embodiment, the master common voltage M-Vcom and the slave common voltage S-Vcom are substantially identical with each other. That is, the master and slave common voltages M-Vcom and S-Vcom are obtained from one signal. Thus, if the master data signal M-DATA is substantially identical with the slave data signal S-DATA, the first to m-th master image signals 01-1 to 01-m are substantially identical with the first to m-th slave image signals 02-1 to 02-m, respectively. When the slave common voltage S-Vcom is inverted by static electricity, the master common voltage M-Vcom is also inverted. The common voltage generator 120 may prevent first to m-th master image signals 01-1 to 01-m from being differentiated from the first to m-th slave image signals 02-1 to 02-m due to static electricity while the master data signal M-DATA is substantially identical with the slave data signal S-DATA. Stated differently, common voltage generator 120 ensures first to m-th master image signals 01-1 to 01-m are consistent with first to m-th slave image signals 02-1 to 02-m when the master data signal M-DATA is substantially identical to the slave data signal S-DATA, even in the presence of static electricity.

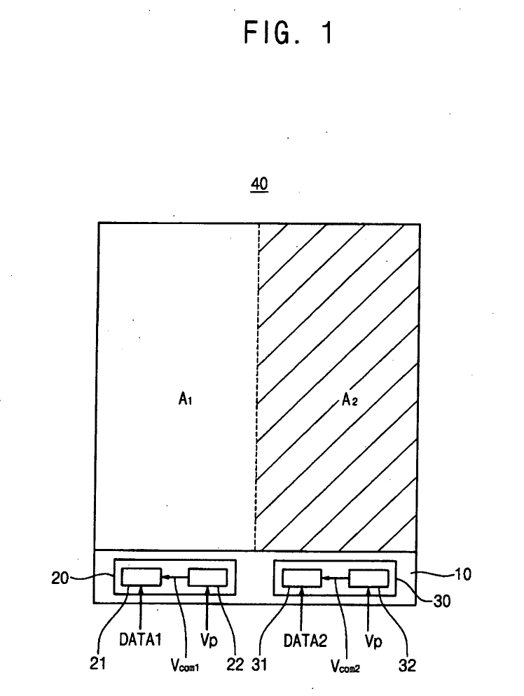

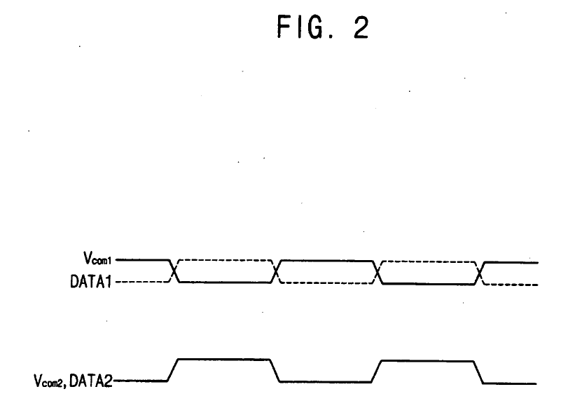

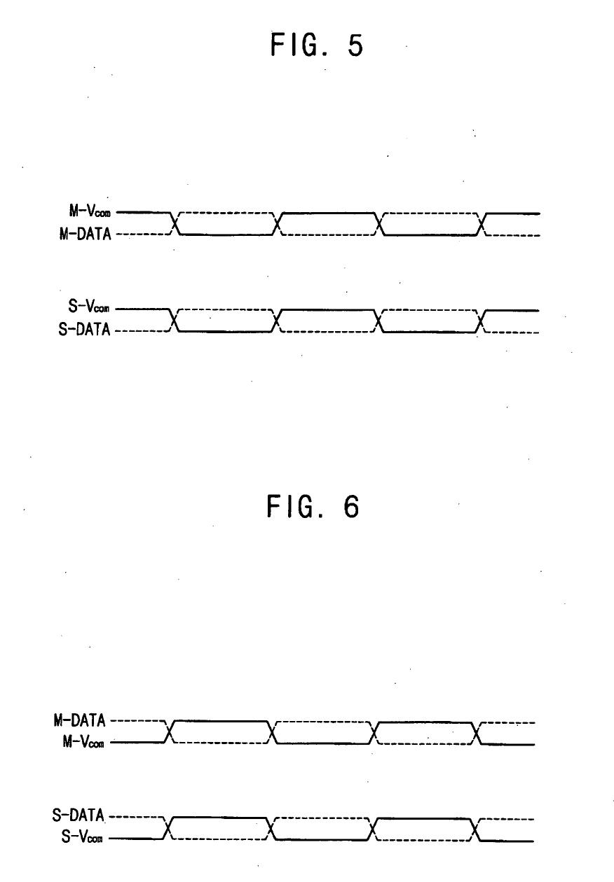

FIG. 5 shows waveform diagrams of exemplary signals applied to the first and second data drivers shown in FIG. 3, and FIG. 6 shows waveform diagrams of exemplary signals applied to the first and second data drivers shown in FIG. 3. In the present embodiment, FIG. 5 shows the master and slave common voltages before inversion by static electricity, and FIG. 6 shows the master and the slave common voltages after inversion by static electricity. Referring now to FIG. 5, the first data driver 100 (shown in FIG. 1) receives the master common voltage M-Vcom and the master data signal M-DATA. The master common voltage M-Vcom has a voltage level periodically inverted (or toggled). The master data signal M-DATA applied to the first data driver 100 has a phase opposite to the master common voltage M-Vcom. The master image signal 01-1 to 01-m (shown in FIG. 3) occurs in accordance with a voltage difference between the master common voltage M-Vcom and the master data signal M-DATA. In the present embodiment, since the voltage difference between the master common voltage M-Vcom and the master data signal M-DATA is great, the master image signal 01-1 to 01-m has a white gray-scale.

The second data driver 200 (shown in FIG. 3) receives the slave common voltage S-Vcom and the slave data signal S-DATA. The slave common voltage S-Vcom has a voltage level periodically inverted. In the present embodiment, the slave data signal S-DATA applied to the second data driver 200 has a phase opposite to the slave common voltage S-Vcom. The slave image signal 02-1 to 02-m (shown in FIG. 3) occurs in accordance with a voltage difference between the slave common voltage S-Vcom and the slave data signal S-DATA. Since the voltage difference between the slave common voltage S-Vcom and the slave data signal S-DATA is great, the slave image signal 02-1 to 02-m has the white gray-scale. As shown in FIG. 6, although both of the master and slave common voltages M-Vcom and S-Vcom are inverted due to static electricity, each of the master and slave image signals 01-1 to 01-m and 02-1 to 02-m has the white gray-scale. Thus, the driving unit 150 may prevent the first to m-th master image signals 01-1 to 01-m and the first to m-th slave image signals 02-1 to 02-m from being differentiated from each other.

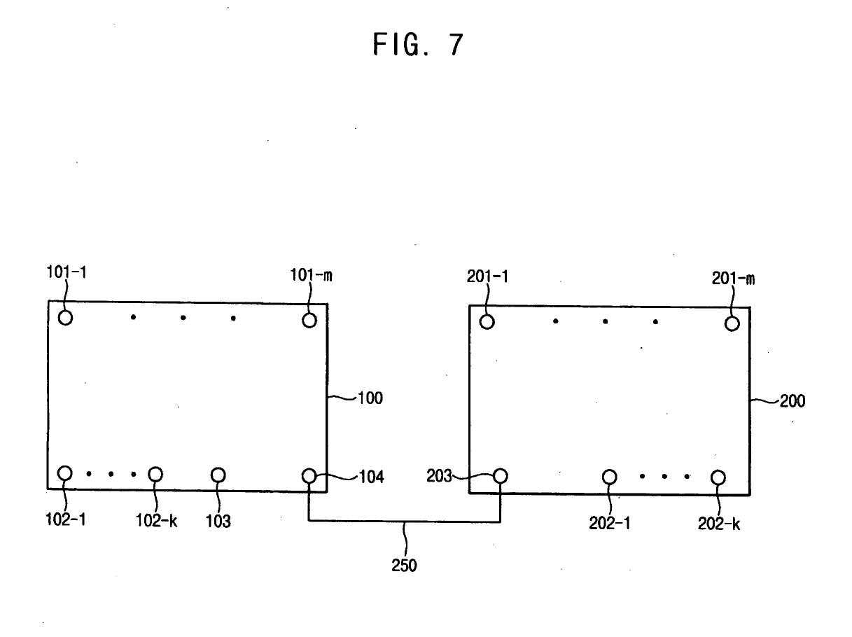

FIG. 7 is a block diagram showing rear sides of the master and slave driving chips shown in FIG. 3.

Referring now to FIG. 7, the master driving chip 100 includes first to k-th master input terminals 102-1 to 102-k receiving the master data signal M-DATA (shown in FIG. 3), a power input terminal 103 receiving the power voltage Vp (shown in FIG. 3), first to m-th master output terminals 101-1 to 101-m outputting first to m-th master image signals 01-1 to 01-m (shown in FIG. 3), and a common voltage output terminal 104 outputting the slave common voltage S-Vcom (shown in FIG. 3). In the present embodiment, “k” is a natural number not less than “2”.

The slave driving chip 200 includes first to k-th slave input terminals 202-1 to 202-k receiving the slave data signal S-DATA (shown in FIG. 3), a common voltage input terminal 203 receiving the slave common voltage S-Vcom from the master driving chip 100, and first to m-th slave output terminals 201-1 to 201-m outputting first to m-th slave image signals 02-1 to 02-m (shown in FIG. 3). The common voltage output terminal 104 and the common voltage input terminal 203 are electrically connected to each other via the connection line 250. Thus, the slave common voltage S-Vcom outputted from the master driving chip 100 is applied to the slave driving chip 200 through the connection line 250.

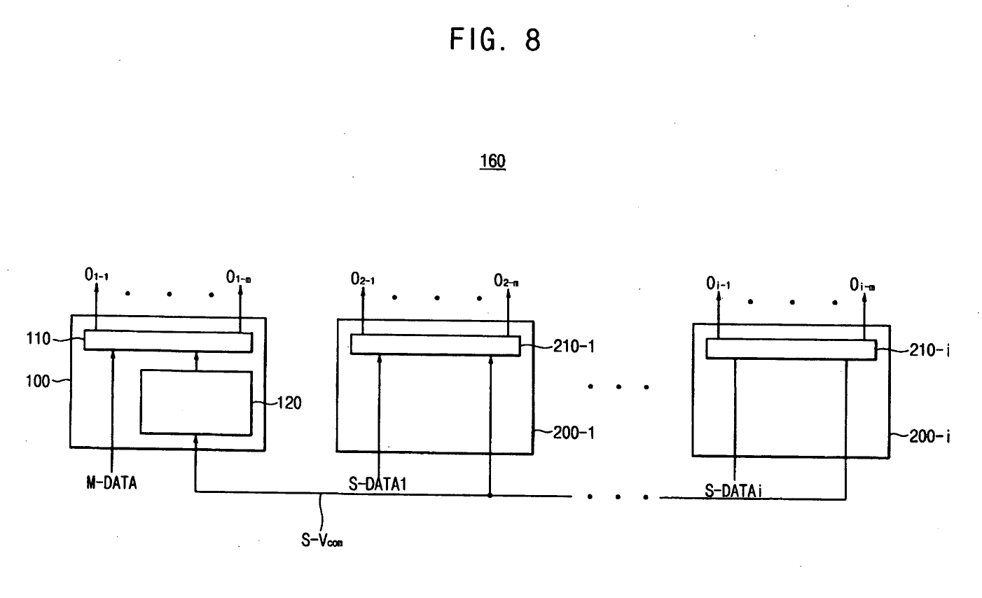

FIG. 8 is block diagram of a driving unit according to a second exemplary embodiment of the present invention. In FIG. 8, the same reference numerals denote the same elements in FIG. 3, and thus the detailed descriptions of the same elements will be omitted. Referring now to FIG. 8, a driving unit 160 according to a second exemplary embodiment of the present invention includes a master driving chip 100 and first to i-th slave driving chips 200-1 to 200-i. In the present embodiment, “i” is a natural number not less than 2.

A common voltage generator 120 within the master driving chip 100 converts an externally provided power voltage Vp to a master common voltage M-Vcom and a slave common voltage S-Vcom. The slave common voltage S-Vcom from the master driving chip 100 is applied to the first to i-th slave driving chips 200-1 to 200-i. Thus, second to i+1 data drivers 210-1 to 210-i installed in each of the first to i-th slave driving chips 200-1 to 200-i output slave image signals 02-1 to 02-m through 0i-1 to 0i-m in response to the slave common voltage S-Vcom. As discussed above, although numbers of the slave driving chips increase, the first to i-th slave driving chips 200-1 to 200-i receive the slave common voltage from only one master driving chip 100. Thus, the driving unit 160 may prevent the first to m-th master image signals 01-1 to 01-m and the first to m-th slave image signals 02-1 to 02-m from being differentiated from each other due to static electricity. In the present embodiment, numbers of the slave driving chips are determined in accordance with numbers of the display panels and a resolution size.

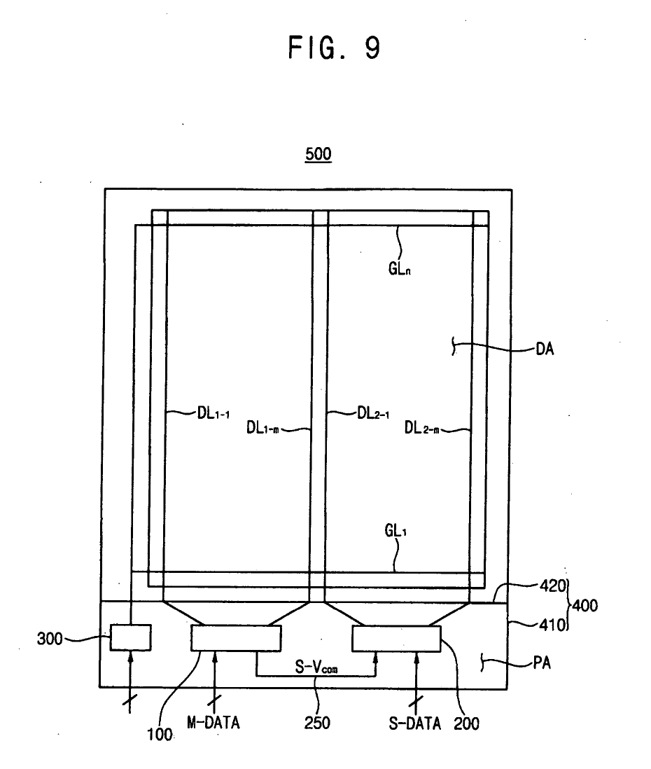

FIG. 9 is a plan view showing a display apparatus according to a third exemplary embodiment of the present invention.

Referring now to FIG. 9, a display apparatus 500 according to a third exemplary embodiment of the present invention includes a display panel 400, a gate driver 300, a master driving chip 100 and a slave driving chip 200. The display panel 400 displays an image in response to a gate signal and first and second image signals. The display panel 400 has a first display substrate 410, a second display substrate 420 facing the first display substrate 410, and a liquid crystal layer (not shown) between the first and second display substrates 410 and 420. Corresponding to a display area DA on which the image is displayed, the first display substrate 410 has first to n-th gate lines GL1 to GLn, a first data line group DL1-1 to DL1-m and a second data line group DL2-1 to DL2-m. The first to n-th gate lines GL1 to GLn cross with and are insulated from the first and second data line groups DL1-1 to DL1-m, and DL2-1 to DL2-m. In the present embodiment, “n” is a natural number not less than “2”.

The gate driver 300 circuit can be implemented as a chip and installed on the first display substrate 410 corresponding to a peripheral area PA adjacent to the display area DA. The gate driver 300 is electrically connected to the first to n-th gate lines GL1 to GLn so as to sequentially apply the gate signal to the first to n-th gate lines GL1 to GLn. The master and slave driving chips 100 and 200 are mounted on the first display substrate 410 corresponding to the peripheral area PA. The master driving chip 100 is electrically connected to the first data line group DL1-1 to DL1-m to apply a first image signal to the first data line group DL1-1 to DL1-m. The slave driving chip 200 is also electrically connected to the second data line group DL2-1 to DL2-m to apply a second image signal to the second data line group DL2-1 to DL2-m. The slave common voltage Vcom from the master driving chip 100 is applied to the slave driving chip 200 through the connection line 250. The connection line 250 is formed in the peripheral area PA of the first display substrate 410.

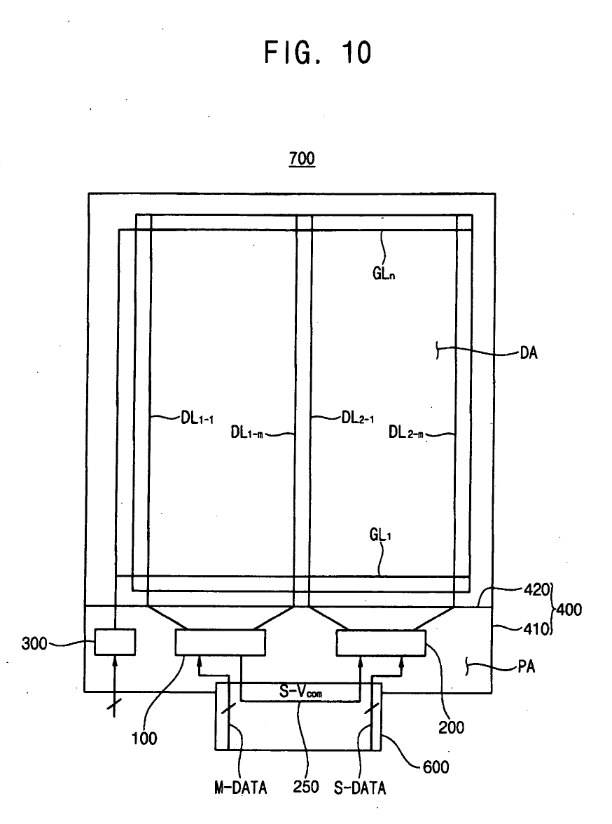

FIG. 10 is a plan view showing a display apparatus according to a fourth exemplary embodiment of the present invention. In FIG. 10, the same reference numerals denote the same elements in FIG. 9, and thus the detailed descriptions of the same elements will be omitted.

Referring now to FIG. 10, a display apparatus 700 according to a fourth exemplary embodiment of the present invention includes a display panel 400, a gate driver 300, a master driving chip 100, a slave driving chip 200 and a flexible film 600. The flexible film 600 is attached to the peripheral area PA of the first display substrate 410. The flexible film 600 receives the master data signal M-DATA and the power voltage (not shown) and applies the master data signal M-DATA and the power voltage (not shown) to the master driving chip 100. The flexible film 600 receives the externally provided slave data signal S-DATA and the slave common voltage S-Vcom from the master driving chip 100 and applies the slave data signal S-DATA and the slave common voltage S-Vcom to the slave driving chip 200. The flexible film 600 has a connection line 250 formed therein so as to connect the master driving chip 100 to the slave driving chip 200. Thus, the slave common voltage S-Vcom outputted from the master driving chip 100 is applied to the slave driving chip 200 through the connection line 250.

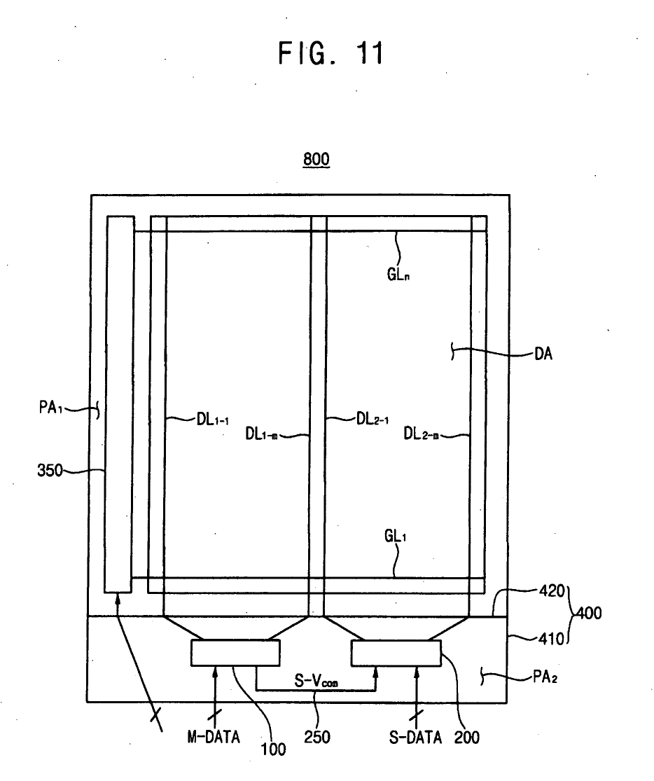

FIG. 11 is a plan view showing a display apparatus according to a fifth exemplary embodiment of the present invention.

Referring now to FIG. 11, a display apparatus 800 according to a fifth exemplary embodiment of the present invention includes a display panel 400, a gate driver 350, a master driving chip 100 and a slave driving chip 200. The display panel 400 includes a first display substrate 410, a second display substrate 420 facing the first display substrate 410 and a liquid crystal layer (not shown) between the first and second display substrates 410 and 420.

Corresponding to a display area DA on which the image is displayed, the first display substrate 410 has first to n-th gate lines GL1 to GLn, a first data line group DL1-1 to DL1-m and a second data line group DL2-1 to DL2-m. The first to n-th gate lines GL1 to GLn cross with and are insulated from the first and second data line groups DL1-1 to DL1-m and DL2-1 to DL2-m. The gate driver 350 is installed on the first display substrate 410 corresponding to a first peripheral area PA1. The gate driver 350 is completely covered by the second display panel 420.

The master and slave driving chips 100 and 200 are mounted on the first display substrate 410 corresponding to a second peripheral area PA2 adjacent to the first peripheral area PA1. As described above, since the gate driver 350 is installed in the display panel 400, numbers of the chips for the display apparatus 800 may be reduced, thereby enhancing productivity of the display apparatus 800. According to the above described driving unit and the display apparatus, the slave driving chip receives the slave common voltage from the master driving chip, and the master common voltage is substantially same with the slave common voltage. Thus, the master common voltage and the slave common voltage are inverted simultaneously when the static electricity occurs, so that the master driving chip and the slave driving chip each output image signals having the gray-scale that are substantially identical with each other. As a result, the display apparatus may prevent occurrence of phenomena wherein left and right screens of the display panel are inverted due to malfunction of the master and slave driving chips.

Although the exemplary embodiments of the present invention have been described, it is understood that the present invention should not be limited to these exemplary embodiments but various changes and modifications can be made by one ordinary skilled in the art within the spirit and scope of the present invention as hereinafter claimed.

What is claimed is:

1. A driving unit, comprising:
a master driving chip having a common voltage generator configured to receive power and generate a master common voltage and a slave common voltage, and a first data driver configured to output a master image signal based on the master common voltage and a master data signal; and
a plurality of slave driving chips, each of the slave driving chips having a second data driver configured to output a slave image signal based on the slave common voltage from the common voltage generator and a slave data signal.

2. The driving unit of claim 1, wherein the master driving chip comprises:
a first input terminal to receive the master data signal;
a second input terminal configured to receive power;
a first output terminal configured to output the master image signal; and
a second output terminal configured to output the slave common voltage.

3. The driving unit of claim 2, wherein each of the slave driving chips comprises:
a third input terminal configured to receive the slave data signal;
a fourth input terminal electrically connected to the second output terminal and configured to receive the slave common voltage; and
a third output terminal configured to output the slave image signal.

4. The driving unit of claim 3, further comprising a connection line configured to electrically connect the second output terminal to the fourth input terminal.

5. The driving unit of claim 1, wherein the master common voltage and the slave common voltage are obtained from one signal so that the master common voltage has a voltage level equal to the slave common voltage, and
each of the master and slave common voltages has a voltage level that is periodically inverted.

6. A display apparatus comprising:
a display panel configured to display an image based on a master image signal, a slave image signal and a gate signal;
a gate driver configured to output the gate signal;
a master driving chip having a common voltage generator configured to receive power and generate a master common voltage and a slave common voltage, and a first data driver configured to output a master image signal based on the master common voltage and a master data signal; and
a plurality of slave driving chips, each of the slave driving chips having a second data driver configured to output a slave image signal based on the slave common voltage from the common voltage generator and a slave data signal.

7. The display apparatus of claim 6, wherein the display panel comprises:
a display area on which the image is displayed; and
a peripheral area adjacent to the display area, and wherein the master driving chip and the slave driving chip are mounted in the peripheral area of the display panel.

8. The display apparatus of claim 7, further comprising a connection line that electrically connects the master driving chip to the slave driving chip and configured to apply the slave common voltage from the master driving chip to the slave driving chips, the connection line being formed in the peripheral area of the display panel.

9. The display apparatus of claim 7, further comprising a flexible film configured to receive the power, the master data signal and the slave data signal, the flexible film being configured to apply the power and the master data signal to the master driving chip and apply the slave data signal to the slave driving chips, the flexible film being attached to the peripheral area of the display panel.

10. The display apparatus of claim 9, wherein the flexible film comprises a connection line electrically connecting the master driving chip to the slave driving chip and configured to apply the slave common voltage from the master driving chip to the slave driving chips.

11. The display apparatus of claim 6, wherein the display panel comprises:
a plurality of first data lines configured to receive the master image signal;
a plurality of second data lines configured to receive the slave image signal; and
a plurality of gate lines configured to receive the gate signal, the gate lines being insulated from and intersecting with the first data lines and the second data lines.

12. The display apparatus of claim 6, wherein the master driving chip comprises:
a first input terminal configured to receive the master data signal;
a second input terminal configured to receive the power;
a first output terminal configured to output the master image signal; and
a second output terminal configured to output the slave common voltage.

13. The display apparatus of claim 12, wherein each of the slave driving chips comprises:
a third input terminal configured to receive the slave data signal;
a fourth input terminal electrically connected to the second output terminal and configured to receive the slave common voltage; and
a third output terminal configured to output the slave image signal.

14. The display apparatus of claim 6, wherein the master common voltage and the slave common voltage are obtained from one signal so that the master common voltage has a voltage level equal to the slave common voltage, and
wherein each of the master and slave common voltages has a voltage level that is periodically inverted.
